(19) United States
(12) Patent Application Publication
(10) Pub. No.: US 2006/0266160 A1
(43) Pub. Date: Nov. 30, 2006

(54) Multifunctional opener

(76) Inventor: Chi-Chun Yeh, Ping Dong Hsien (TW)

Correspondence Address: NIKOLAI & MERSEREAU, P.A., 900 SECOND AVENUE SOUTH, SUITE 820, MINNEAPOLIS, MN, 55402, US

(21) Appl. No.: 11/141,081

(22) Filed: May 31, 2005

(51) Int. Cl. B67B 7/18

(52) U.S. Cl. 81/3.4

(57) ABSTRACT

A multifunctional opener includes a main body having two opposite sides formed with two upright clamping portions and having an inside formed with an engaging recess located between the two clamping portions. Thus, the clamping groove and the engaging recess of the main body are used to open seal caps of different sizes, thereby enhancing the versatility of the opener. In addition, the clamping groove or the engaging recess of the main body is engaged with the periphery of the seal cap so that the seal cap is closely clamped by the main body, thereby facilitating a user opening the seal cap.

### BACKGROUND OF THE INVENTION

1. Field of the Invention

The present invention relates to an opener, and more particularly to a multifunctional opener that is used to open caps of different specifications and sizes.

2. Description of the Related Art

A conventional can opener in accordance with the prior art shown in FIG. 7 comprises a handle 2 having a distal end formed with a plate 1 having an inside formed with an arc-shaped slot 3. In operation, the arc-shaped slot 3 is rested on the top face and the lower edge of a snap type cap of a container, such as a can or the like. Then, the handle 2 is pivoted upward to turn the arc-shaped slot 3 to detach the cap from the container, thereby opening the container. However, the conventional can opener only has a single function to open the snap type cap, thereby limiting the versatility of the opener. In addition, the user has to apply a larger force on the handle 2 so as to turn the arc-shaped slot 3 and to detach the cap from the container, thereby wasting the manual work.

### SUMMARY OF THE INVENTION

The primary objective of the present invention is to provide a multifunctional opener that is used to open caps of different specifications and sizes.

Another objective of the present invention is to provide an opener that is operated easily and conveniently, thereby saving the manual work.

A further objective of the present invention is to provide an opener, wherein the punching portion, the resting portion and the arc-shaped slot of the main body are used to open a snap type cap while the clamping groove and the engaging recess of the main body are used to open rotation type seal caps of different sizes, thereby enhancing the versatility of the opener.

A further objective of the present invention is to provide an opener, wherein the clamping groove or the engaging recess of the main body is engaged with the periphery of the seal cap so that the seal cap is closely clamped by the main body, thereby facilitating a user opening the seal cap.

A further objective of the present invention is to provide an opener, wherein the user only apply a rotation force on the main body to rotate the seal cap so as to open the seal cap, so that the seal cap is opened easily in an energy-saving manner, thereby saving the manual work.

Further benefits and advantages of the present invention will become apparent after a careful reading of the detailed description with appropriate reference to the accompanying drawings.

### BRIEF DESCRIPTION OF THE DRAWINGS

FIG. 1 is a perspective view of an opener in accordance with the preferred embodiment of the present invention;

FIG. 2 is a bottom perspective view of the opener as shown in FIG. 1;

FIG. 3 is a schematic operational view of the opener as shown in FIG. 1;

FIG. 4 is a plan view of the opener as shown in FIG. 3;

FIG. 5 is a schematic operational view of the opener as shown in FIG. 1;

FIG. 6 is a plan view of the opener as shown in FIG. 5; and

FIG. 7 is a perspective view of a conventional can opener in accordance with the prior art.

### DETAILED DESCRIPTION OF THE INVENTION

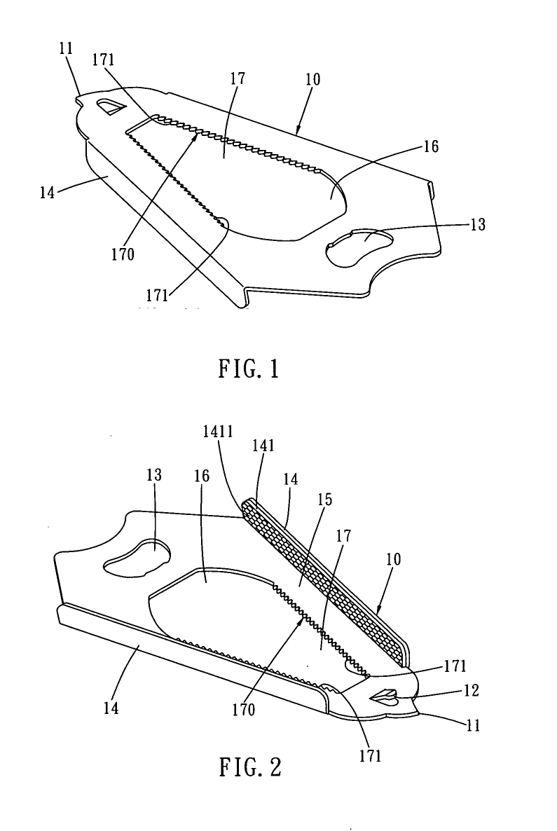

Referring to the drawings and initially to FIGS. 1 and 2, a multifunctional opener in accordance with the preferred embodiment of the present invention comprises a main body 10 having two opposite sides formed with two upright clamping portions 14 and having an inside formed with an engaging recess 17 located between the two clamping portions 14, and at least one anti-slip pad 141 mounted on an inner face of either one of the two clamping portions 14 of the main body 10.

The main body 10 is an integrally formed flat plate and has a gradually reduced shape. The main body 10 has a first end and a second end having a width greater than that of the first end. The first end of the main body 10 is formed with a sharp punching portion 11 and a hook-shaped resting portion 12, and the second end of the main body 10 is formed with an arc-shaped slot 13. The main body 10 has a gradually reduced clamping groove 15 defined between the two clamping portions 14.

The two clamping portions 14 of the main body 10 are inclined relative to each other and are extended outward from the first end to the second end of the main body 10 so that a distance between the two clamping portions 14 is gradually increased from the first end to the second end of the main body 10.

The engaging recess 17 of the main body 10 has a gradually reduced shape and has two opposite sides 170 each formed with a plurality of oblique engaging teeth 171. The engaging teeth 171 of the two opposite sides 170 of the engaging recess 17 are directed toward different directions.

The engaging recess 17 of the main body 10 has a first end and a second end having a width greater than that of the first end. The second end of the engaging recess 17 is formed with a mounting hole 16. The two opposite sides 170 of the engaging recess 17 are inclined relative to each other and are extended outward from the first end to the second end of the engaging recess 17 so that a distance between the two opposite sides 170 of the engaging recess 17 is gradually increased from the first end to the second end of the engaging recess 17. The engaging recess 17 has a maximum width substantially equal to a minimum distance of the clamping groove 15.

The anti-slip pad 141 has a surface provided with a plurality of anti-slip bosses 1411 to provide an anti-slip effect.

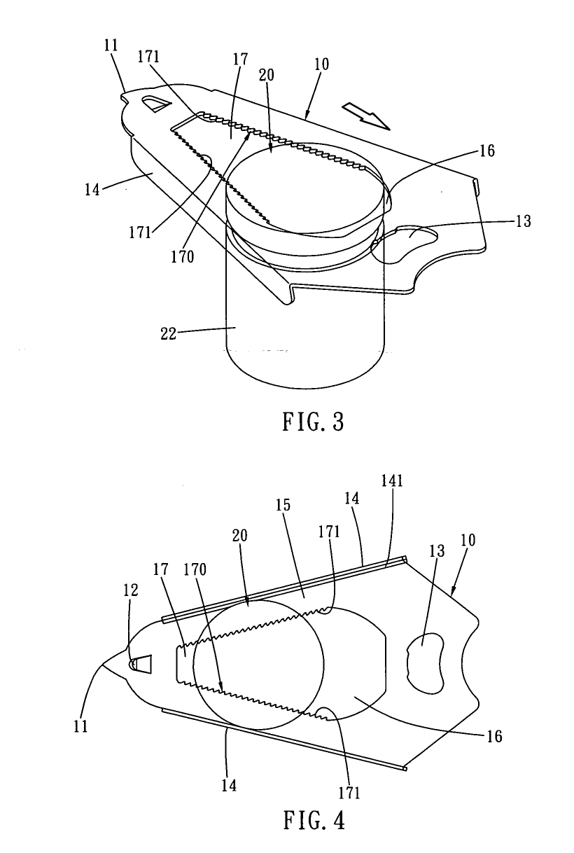

In operation, referring to FIGS. 3 and 4, when the opener is used to open a seal cap 20 of a container 22 having a larger size, the clamping groove 15 of the main body 10 is mounted on the seal cap 20 which is located between the two clamping portions 14. Then, the main body 10 is moved relative to the seal cap 20 so that the seal cap 20 is gradually moved from the wider second end to the narrower first end of the main body 10 and is clamped between the two clamping portions 14. At this time, the anti-slip pad 141 is pressed on the periphery of the seal cap 20 so that the seal cap 20 is closely clamped between the two clamping portions 14. Then, the main body 10 is rotated relative to the seal cap 20 to rotate and loosen the seal cap 20, thereby opening the container 22.

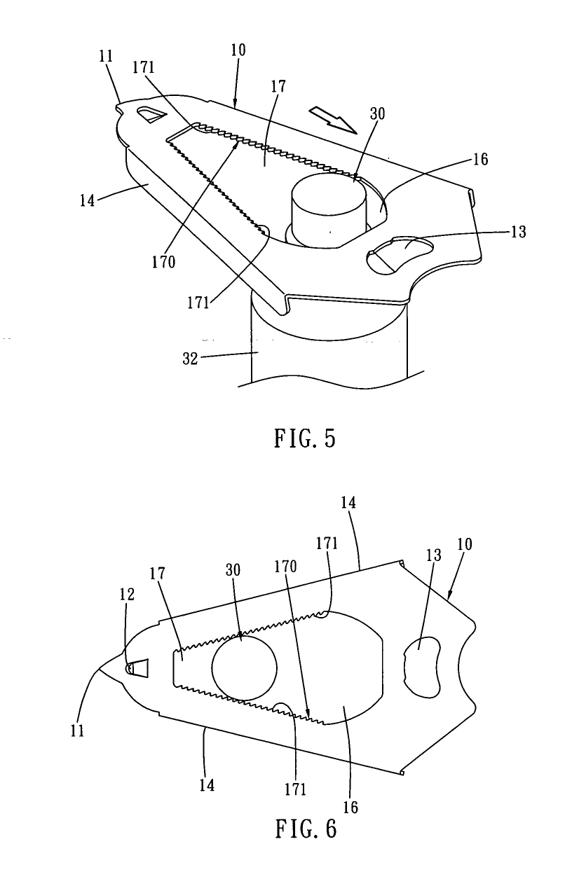

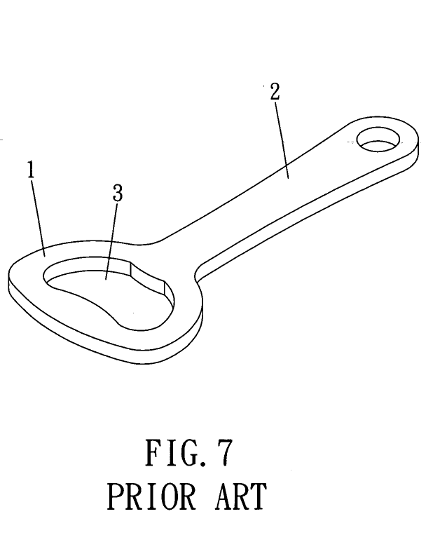

Alternatively, referring to FIGS. 5 and 6, when the opener is used to open a seal cap 30 of a container 32 having a larger size, the mounting hole 16 of the main body 10 is mounted on the seal cap 30 which is located between the two opposite sides 170 of the engaging recess 17. Then, the main body 10 is moved relative to the seal cap 30 so that the seal cap 30 is gradually moved from the wider second end to the narrower first end of the engaging recess 17 and is clamped between the engaging teeth 171 of the two opposite sides 170 of the engaging recess 17. At this time, the engaging teeth 171 are engaged with the periphery of the seal cap 30 so that the seal cap 30 is closely clamped between the two opposite sides 170 of the engaging recess 17. Then, the main body 10 is rotated relative to the seal cap 30 to rotate and loosen the seal cap 30, thereby opening the container 32.

Alternatively, the punching portion 11, the resting portion 12 and the arc-shaped slot 13 of the main body 10 are used to open a snap type cap.

Accordingly, the punching portion 11, the resting portion 12 and the arc-shaped slot 13 of the main body 10 are used to open a snap type cap while the clamping groove 15 and the engaging recess 17 of the main body 10 are used to open rotation type seal caps of different sizes, thereby enhancing the versatility of the opener. In addition, the clamping groove 15 or the engaging recess 17 of the main body 10 is engaged with the periphery of the seal cap so that the seal cap is closely clamped by the main body 10, thereby facilitating a user opening the seal cap. Further, the user only apply a rotation force on the main body 10 to rotate the seal cap so as to open the seal cap, so that the seal cap is opened easily in an energy-saving manner, thereby saving the manual work.

Although the invention has been explained in relation to its preferred embodiment(s) as mentioned above, it is to be understood that many other possible modifications and variations can be made without departing from the scope of the present invention. It is, therefore, contemplated that the appended claim or claims will cover such modifications and variations that fall within the true scope of the invention.

What is claimed is:

1. An opener, comprising:
a main body having two opposite sides formed with two upright clamping portions and having an inside formed with an engaging recess located between the two clamping portions.

2. The opener in accordance with claim 1, wherein the main body has a first end and a second end having a width greater than that of the first end.

3. The opener in accordance with claim 2, wherein the two clamping portions of the main body are inclined relative to each other and are extended outward from the first end to the second end of the main body so that a distance between the two clamping portions is gradually increased from the first end to the second end of the main body.

4. The opener in accordance with claim 2, wherein the first end of the main body is formed with a sharp punching portion and a hook-shaped resting portion.

5. The opener in accordance with claim 2, wherein the second end of the main body is formed with an arc-shaped slot.

6. The opener in accordance with claim 1, wherein the main body has a gradually reduced clamping groove defined between the two clamping portions.

7. The opener in accordance with claim 1, wherein the engaging recess of the main body has two opposite sides each formed with a plurality of oblique engaging teeth.

8. The opener in accordance with claim 7, wherein the engaging teeth of the two opposite sides of the engaging recess are directed toward different directions.

9. The opener in accordance with claim 1, wherein the engaging recess of the main body has a gradually reduced shape.

10. The opener in accordance with claim 1, wherein the engaging recess of the main body has a first end and a second end having a width greater than that of the first end.

11. The opener in accordance with claim 10, wherein the second end of the engaging recess is formed with a mounting hole.

12. The opener in accordance with claim 10, wherein the two opposite sides of the engaging recess are inclined relative to each other and are extended outward from the first end to the second end of the engaging recess so that a distance between the two opposite sides of the engaging recess is gradually increased from the first end to the second end of the engaging recess.

13. The opener in accordance with claim 6, wherein the engaging recess has a maximum width substantially equal to a minimum distance of the clamping groove.

14. The opener in accordance with claim 1, wherein the main body is an integrally formed flat plate.

15. The opener in accordance with claim 1, wherein the main body has a gradually reduced shape.

16. The opener in accordance with claim 1, further comprising at least one anti-slip pad mounted on an inner face of either one of the two clamping portions of the main body.

17. The opener in accordance with claim 16, wherein the anti-slip pad has a surface provided with a plurality of anti-slip bosses to provide an anti-slip effect.
